(19) United States
(12) Patent Application Publication
(10) Pub. No.: US 2026/0079173 A1
(43) Pub. Date: Mar. 19, 2026

(54) SENSOR AND ELECTRONIC DEVICE

(71) Applicant: KABUSHIKI KAISHA TOSHIBA, Tokyo (JP)

(72) Inventors: Kei MASUNISHI, Kawasaki Kanagawa (JP); Etsuji OGAWA, Kawasaki Kanagawa (JP); Yasushi TOMIZAWA, Fuchu Tokyo (JP); Kengo UCHIDA, Kawasaki Kanagawa (JP); Fumitaka ISHIBASHI, Kawasaki Kanagawa (JP); Daiki ONO, Yokohama Kanagawa (JP); Fumito MIYAZAKI, Kawasaki Kanagawa (JP); Hideaki MURASE, Yokohama Kanagawa (JP); Naoki HIRAMATSU, Kawasaki Kanagawa (JP)

(73) Assignee: KABUSHIKI KAISHA TOSHIBA, Tokyo (JP)

(21) Appl. No.: 19/241,490

(22) Filed: Jun. 18, 2025

(30) Foreign Application Priority Data
Sep. 18, 2024 (JP) 2024-160988

(51) Int. Cl. G01P 15/08

(52) U.S. Cl. CPC G01P 15/08

(57) ABSTRACT

According to one embodiment, a sensor includes an element section, and a controller. The element section including a base, a first fixed portion, a first other fixed portion, a first fixed electrode, a first other fixed electrode, and a first movable member. The first movable member includes a first movable base supported by the first other fixed portion, a first beam, and a first movable structure. The first movable structure includes a first movable electrode, a first other movable electrode, and a first movable connecting portion. The controller performs first and second operations. The controller is configured to control a first potential between the first other fixed electrode and the first other movable electrode in the first operation. The controller is configured to apply a first AC voltage between the first fixed electrode and the first movable electrode in the second operation.

### CROSS-REFERENCE TO RELATED APPLICATIONS

This application is based upon and claims the benefit of priority from Japanese Patent Application No.2024-160988, filed on Sep. 18, 2024; the entire contents of which are incorporated herein by reference.

### FIELD

Embodiments described herein relate generally to a sensor and an electronic device.

### BACKGROUND

For example, there is a sensor using a MEMS structure. It is desired to improve the characteristics of the sensor.

### BRIEF DESCRIPTION OF THE DRAWINGS

FIG. 1 is a schematic plan view illustrating a part of a sensor according to a first embodiment;

FIG. 2 is a schematic plan view illustrating the sensor according to the first embodiment;

FIG. 3 is a schematic cross-sectional view illustrating the sensor according to the first embodiment;

FIG. 4 is a schematic plan view illustrating a part of the sensor according to the first embodiment;

FIG. 5 is a schematic plan view illustrating a part of a sensor according to the first embodiment;

FIG. 6 is a schematic plan view illustrating a part of a sensor according to the first embodiment;

FIG. 7 is a schematic plan view illustrating a part of a sensor according to the first embodiment;

FIG. 8 is a schematic plan view illustrating a part of a sensor according to the first embodiment;

FIG. 9 is a schematic diagram illustrating an electronic device according to a second embodiment;

FIGS. 10A to 10G are schematic diagrams illustrating applications of the electronic device according to the embodiment; and

FIGS. 11A and 11B are schematic diagrams illustrating applications of the sensor according to the embodiment.

### DETAILED DESCRIPTION

According to one embodiment, a sensor includes an element section, and a controller. The element section including a base, a first fixed portion fixed to the base, a first other fixed portion fixed to the base, a first fixed electrode fixed to the base, a first other fixed electrode fixed to the base, and a first movable member. A first gap is provided between the base and the first movable member. The first movable member includes a first movable base supported by the first other fixed portion, a first beam, and a first movable structure. The first beam includes a first beam portion, a first other beam portion, and a first intermediate beam portion. The first beam portion is connected to the first fixed portion. The first other beam portion is connected to the first movable base. A second direction from the first beam portion to the first other beam portion crosses a first direction from the base to the first other fixed portion. The first intermediate beam portion is between the first beam portion and the first other beam portion. The first movable structure includes a first movable electrode, a first other movable electrode, and a first movable connecting portion. A direction from the first movable electrode to the first other movable electrode is along a third direction crossing a plane including the first direction and the second direction. The first movable electrode and the first other movable electrode extend along the second direction. The first movable connecting portion is connected to the first intermediate beam portion. The first movable connecting portion extends along the third direction. The first movable connecting portion is connected to the first movable electrode and the first other movable electrode. The controller is configured to perform a first operation and a second operation. The controller is configured to control a first potential between the first other fixed electrode and the first other movable electrode in the first operation. The controller is configured to apply a first AC voltage between the first fixed electrode and the first movable electrode in the second operation.

Various embodiments are described below with reference to the accompanying drawings.

The drawings are schematic and conceptual; and the relationships between the thickness and width of portions, the proportions of sizes among portions, etc., are not necessarily the same as the actual values. The dimensions and proportions may be illustrated differently among drawings, even for identical portions.

In the specification and drawings, components similar to those described previously or illustrated in an antecedent drawing are marked with like reference numerals, and a detailed description is omitted as appropriate.

### First Embodiment

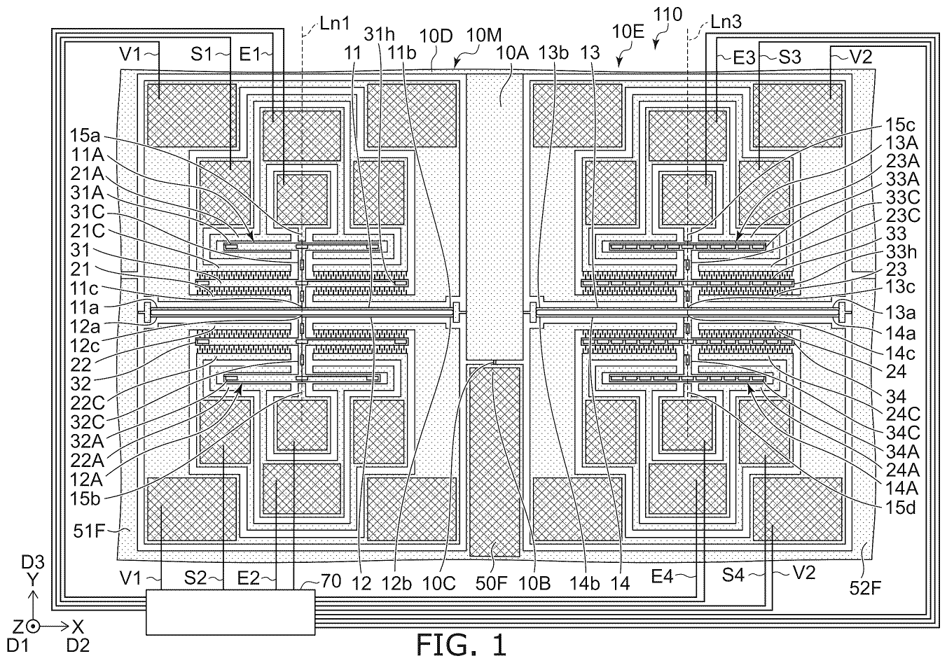

FIG. 1 is a schematic plan view illustrating a part of a sensor according to a first embodiment.

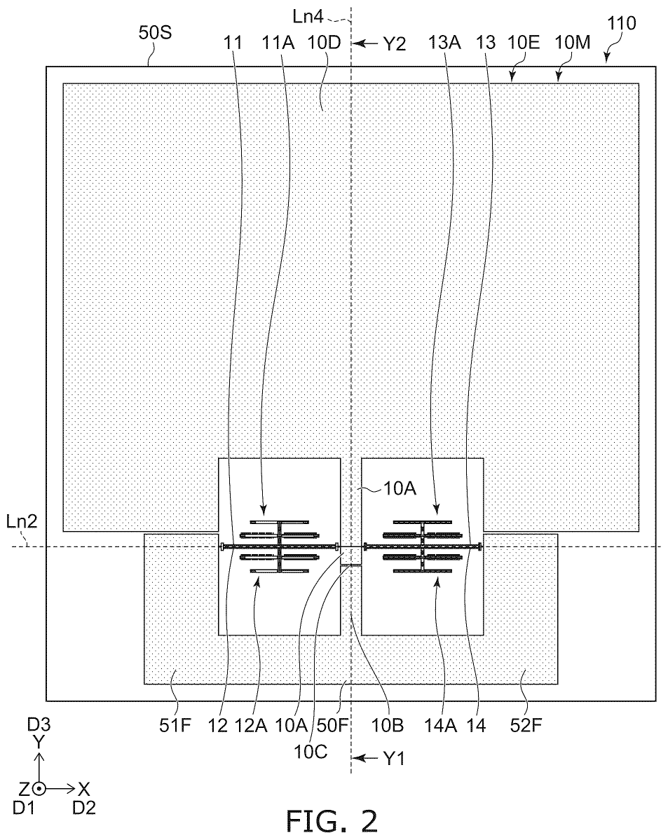

FIG. 2 is a schematic plan view illustrating the sensor according to the first embodiment.

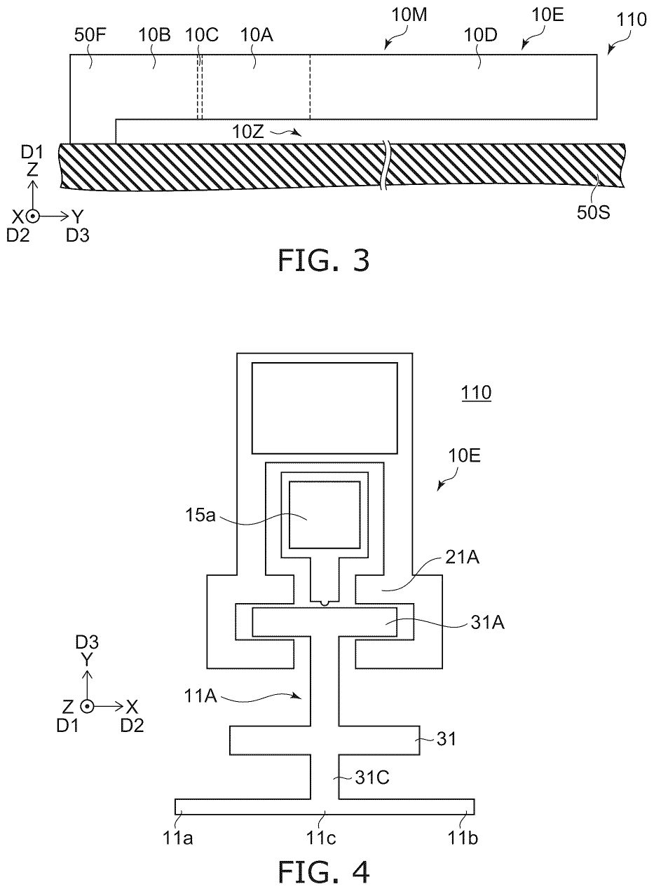

FIG. 3 is a schematic cross-sectional view illustrating the sensor according to the first embodiment.

FIG. 3 is a cross-sectional view taken along the line Y1-Y2 in FIG. 2.

FIG. 4 is a schematic plan view illustrating a part of the sensor according to the first embodiment.

As shown in FIGS. 1 to 3, a sensor 110 according to the embodiment includes an element section 10E and a controller 70.

As shown in FIGS. 2 and 3, the element section 10E includes a base 50S, a first fixed portion 51F, and a first other fixed portion 50F. The first fixed portion 51F and the first other fixed portion 50F are fixed to the base 50S. For example, the first fixed portion 51F may be fixed to the base 50S via the first other fixed portion 50F. In this case, a gap may be provided between the base 50S and the first fixed portion 51F. The relative positions of the first fixed portion 51F and the base 50S are substantially fixed. As described below, the element section 10E may further include a second fixed portion 52F.

As shown in FIG. 1, the element section 10E further includes a first fixed electrode 21 and a first other fixed electrode 21A. The first fixed electrode 21 and the first other fixed electrode 21A are fixed to the base 50S. In FIG. 2, these fixed electrodes are omitted.

As shown in FIG. 2, the element section 10E further includes a first movable member 10M. The first movable member 10M is supported by the first other fixed portion 50F. As shown in FIG. 3, a first gap 10Z is provided between the base 50S and the first movable member 10M. The element section 10E has a MEMS (Micro Electro Mechanical Systems) structure.

As shown in FIG. 1, the first movable member 10M includes a first movable base 10A, a first beam 11, and a first movable structure 11A. The first movable base 10A is supported by the first other fixed portion 50F.

The first beam 11 includes a first beam portion 11a, a first other beam portion 11b, and a first intermediate beam portion 11c. The first beam portion 11a is connected to the first fixed portion 51F. The first other beam portion 11b is connected to the first movable base 10A. A second direction D2 from the first beam portion 11a to the first other beam portion 11b crosses a first direction D1 (see FIG. 3) from the base 50S to the first other fixed portion 50F.

The first direction D1 is defined as a Z-axis direction. One direction perpendicular to the Z-axis direction is defined as an X-axis direction. A direction perpendicular to the Z-axis and X-axis directions is defined as a Y-axis direction. In the example of the sensor 110, the second direction D2 may be the X-axis direction.

The first intermediate beam portion 11c is located between the first beam portion 11a and the first other beam portion 11b. For example, the first intermediate beam portion 11c may be at the center of the first beam portion 11a and the first other beam portion 11b.

The first movable structure 11A includes a first movable electrode 31, a first other movable electrode 31A, and a first movable connecting portion 31C. A direction from the first movable electrode 31 to the first other movable electrode 31A is along a third direction D3. The third direction D3 crosses a plane including the first direction D1 and the second direction D2. The third direction D3 may be, for example, the Y-axis direction.

The first movable electrode 31 and the first other movable electrode 31A extend along the second direction D2. The length of the first movable electrode 31 along the second direction D2 is longer than the length of the first movable electrode 31 along the third direction D3. The length of the first other movable electrode 31A along the second direction D2 is longer than the length of the first other movable electrode 31A along the third direction D3.

The first movable connecting portion 31C is connected to the first intermediate beam portion 11c. The first movable connecting portion 31C extends along the third direction D3. For example, the length of the first movable connecting portion 31C along the third direction D3 is longer than the length of the first movable connecting portion 31C along the second direction D2. The first movable connecting portion 31C is connected to the first movable electrode 31 and the first other movable electrode 31A.

The controller 70 is configured to perform a first operation and a second operation. The controller 70 is configured to control a first potential E1 between the first other fixed electrode 21A and the first other movable electrode 31A in the first operation. The controller 70 is configured d to apply a first AC voltage V1 between the first fixed electrode 21 and the first movable electrode 31 in the second operation.

For example, in the second operation, the first AC voltage V1 causes the first beam 11 to vibrate. Meanwhile, stress is applied to the first beam 11 due to an acceleration applied to the element section 10E. The stress, for example, changes the resonant frequency of the first beam 11. By detecting the change in the resonant frequency, it is possible to detect the acceleration applied to the element section 10E. The method of detecting the resonant frequency is arbitrary. For example, information related to the resonant frequency may be detected electrically or optically. The second operation corresponds to at least a part of the detection operation.

In the embodiment, in the first operation, the first potential E1 between the first other fixed electrode 21A and the first other movable electrode 31A is controlled. This allows, for example, the vibration characteristics (e.g., resonant frequency) of the first beam 11 in the absence of external acceleration to be appropriately controlled. For example, correction is performed. The first operation corresponds to, for example, a correction operation (or an adjustment operation).

For example, due to variations in the manufacturing process of the element section 10E, non-uniformity may occur in the structure included in the element section 10E. Due to the non-uniformity in the structure, the vibration characteristics (e.g., resonant frequency) of the first beam 11 may shift from the desired value. Even in such a case, by appropriately controlling the first potential E1, it is possible to bring the vibration characteristics (e.g., resonant frequency) of the first beam 11 closer to the desired value. This enables detection with higher accuracy. According to the embodiment, it is possible to provide a sensor whose characteristics can be improved.

In the example of the sensor 110, the element section 10E further includes a first opposing fixed electrode 21C. The first opposing fixed electrode 21C is fixed to the base 50S. The first opposing fixed electrode 21C faces the first movable electrode 31. The controller 70 is configured to detect a first signal S1 between the first opposing fixed electrode 21C and the first movable electrode 31 in the second operation. The first signal S1 corresponds to the vibration state of the first beam 11. The vibration state (e.g., resonant frequency) of the first beam 11 can be electrically detected using the first opposing fixed electrode 21C.

The first signal S1 is configured to change in response to changes in the acceleration applied to the element section 10E. For example, the first signal S1 responds to changes in the first resonant frequency of the first beam 11, which changes in response to changes in the acceleration. Meanwhile, as already described, the controller 70 is configured to control the first potential E1 in the first operation to correct the first resonant characteristic of the first beam 11.

As shown in FIG. 1, in the sensor 110, at least a part of the first movable electrode 31 is between the first fixed electrode 21 and the first opposing fixed electrode 21C in the third direction D3.

In the third direction D3, the first movable electrode 31 is between the first beam 11 and the first other movable electrode 31A. A distance along the third direction D3 between the first beam 11 and the first movable electrode 31 is shorter than the distance along the third direction D3 between the first beam 11 and the first other movable electrode 31A. For example, stable detection operations and stable adjustment operations become easier.

For example, the distance along the third direction D3 between the first beam 11 and the first movable electrode 31 may be shorter than a distance along the third direction D3 between the first movable electrode 31 and the first other movable electrode 31A. The length along the second direction D2 of the first movable electrode 31 may be longer than the length along the second direction D2 of the first other movable electrode 31A.

In the example of FIG. 1, at least a part of the first other movable electrode 31A is between a part of the first other fixed electrode 21A and another part of the first other fixed electrode 21A in the third direction D3. The first other movable electrode 31A includes a portion (first opposing portion) that faces a part of the first other fixed electrode 21A in the third direction D3. The first other movable electrode 31A includes a portion (first other opposing portion) that faces another part of the first other fixed electrode 21A in the third direction D3. For example, a length of the first opposing portion in the second direction D2 may be substantially the same as a length of the first other opposing portion in the second direction D2. At least a part of the first other movable electrode 31A is between a part of the first other fixed electrode 21A and another part of the first other fixed electrode 21A in the second direction D2. The vibration characteristics of the first beam 11 can be controlled more stably.

FIG. 4 illustrates an enlarged view of a portion including the first movable structure 11A. In FIG. 4, the fixed electrodes (e.g., the first fixed electrode 21 and the first opposing fixed electrode 21C) are omitted. As shown in FIGS. 1 and 4, the element section 10E may further include a first fixed structure 15a. The first fixed structure 15a is fixed to the base 50S. The first fixed structure 15a faces the first movable structure 11A. For example, the first fixed structure 15a faces the first other movable electrode 31A in the third direction D3. The potential of the first fixed structure 15a may be the same as the potential of the first movable structure 11A. The first fixed structure 15a may, for example, suppress excessive displacement of the first movable structure 11A. The first fixed structure 15a may, for example, be a stopper.

As shown in FIG. 1, the first movable electrode 31 and the first fixed electrode 21 may form a first comb-tooth electrode pair. The first movable electrode 31 and the first opposing fixed electrode 21C may form a first opposing comb-tooth electrode pair.

As shown in FIG. 1, for example, the first movable structure 11A may be symmetrical with respect to a first straight line Ln1 that passes through the first intermediate beam portion 11c and is along the third direction D3. This allows for detection with higher accuracy.

As shown in FIG. 1, the element section 10E may further include a second fixed electrode 22 and a second other fixed electrode 22A. The second fixed electrode 22 and the second other fixed electrode 22A are fixed to the base 50S. The first movable member 10M may further include a second beam 12 and a second movable structure 12A.

The first beam 11 is between the second movable structure 12A and the first movable structure 11A in the third direction D3. The second beam 12 is between the second movable structure 12A and the first beam 11 in the third direction D3. The second beam 12 extends along the second direction D2.

For example, the second beam 12 includes a second beam portion 12a, a second other beam portion 12b, and a second intermediate beam portion 12c. The second beam portion 12a is connected to the first fixed portion 51F. The second other beam portion 12b is connected to the first movable base 10A. A direction from the second beam portion 12a to the second other beam portion 12b is along the second direction D2. The second intermediate beam portion 12c is located between the second beam portion 12a and the second other beam portion 12b. The second intermediate beam portion 12c may be at the center of the second beam portion 12a and the second other beam portion 12b.

The second movable structure 12A includes a second movable electrode 32, a second other movable electrode 32A, and a second movable connecting portion 32C. A direction from the second other movable electrode 32A to the second movable electrode 32 is along the third direction D3. The second movable electrode 32 and the second other movable electrode 32A extend along the second direction D2. The second movable connecting portion 32C is connected to the second intermediate beam portion 12c. The second movable connecting portion 32C extends along the third direction D3. The second movable connecting portion 32C is connected to the second movable electrode 32 and the second other movable electrode 32A.

The controller 70 is configured to control a second potential E2 between the second other fixed electrode 22A and the second other movable electrode 32A in the first operation. The controller 70 is configured to apply the first AC voltage V1 between the second fixed electrode 22 and the second movable electrode 32 in the second operation.

In the first operation (e.g., adjustment operation), the second potential E2 is controlled, and, for example, the vibration characteristics (e.g., resonant frequency) of the second beam 12 are corrected (adjusted).

As shown in FIG. 1, the element section 10E may further include a second opposing fixed electrode 22C. The second opposing fixed electrode 22C is fixed to the base 50S. The second opposing fixed electrode 22C faces the second movable electrode 32. The controller 70 may be configured to detect a second signal S2 between the second opposing fixed electrode 22C and the second movable electrode 32 in the second operation. The second signal S2 is configured to change in response to changes in the acceleration applied to the element section 10E. By detecting the second signal S2, information regarding the acceleration is obtained.

For example, the second signal S2 corresponds to a change in the second resonant frequency of the second beam 12, which changes in response to a change in the acceleration. The controller 70 may be configured to output a first value based on the first signal S1 and the second signal S2 in the second operation. For example, the first value may include a calculation result of the first signal S1 and the second signal S2. For example, the influence of noise and the like is suppressed.

The above-mentioned first operation (e.g., adjustment operation) may correct the difference in the resonant frequency of the two beams. For example, by controlling the first operation, for example, an appropriate soft spring effect can be obtained. For example, an appropriate tuning fork operation can be obtained in the two beams. For example, a high Q value can be obtained. For example, the effects of characteristic degradation caused by variations in the manufacturing process can be suppressed. For example, thermomechanical noise can be reduced. High accuracy detection results can be obtained.

For example, in the first operation, the controller 70 is configured to control the second potential E2 to correct the second resonance characteristic of the second beam 12.

For example, the controller 70 may be configured to make a first absolute value of the first potential E1 greater than a second absolute value of the second potential E2 in the first operation when the first resonant frequency of the first beam 11 is higher than the second resonant frequency of the second beam 12. The controller 70 may be configured to make the absolute value of the first potential E1 greater than 0 and the second absolute value of the second potential E2 substantially 0 in the first operation when the first resonant frequency is higher than the second resonant frequency.

For example, the controller 70 may be configured to make the second absolute value of the second potential E2 greater than the first absolute value of the first potential E1 in the first operation when the second resonant frequency of the second beam 12 is higher than the first resonant frequency of the first beam 11. The controller 70 may be configured to make the absolute value of the second potential E2 greater than 0 and to make the first absolute value of the first potential E1 substantially 0 in the first operation when the second resonant frequency is higher than the first resonant frequency.

As shown in FIG. 1, in the sensor 110, at least a part of the second movable electrode 32 is between the second fixed electrode 22 and the second opposing fixed electrode 22C in the third direction D3.

In the third direction D3, the second movable electrode 32 is between the second beam 12 and the second other movable electrode 32A. A distance along the third direction D3 between the second beam 12 and the second movable electrode 32 is shorter than a distance along the third direction D3 between the second beam 12 and the second other movable electrode 32A. For example, stable detection operations and stable adjustment operations become easier.

For example, the distance along the third direction D3 between the second beam 12 and the second movable electrode 32 may be shorter than a distance along the third direction D3 between the second movable electrode 32 and the second other movable electrode 32A. A length along the second direction D2 of the second movable electrode 32 may be longer than a length along the second direction D2 of the second other movable electrode 32A.

In the example of FIG. 1, at least a part of the second other movable electrode 32A is between a part of the second other fixed electrode 22A and another part of the second other fixed electrode 22A in the third direction D3. The second other movable electrode 32A includes a portion (second opposing portion) that faces a part of the second other fixed electrode 22A in the third direction D3. The second other movable electrode 32A includes a portion (second other opposing portion) that faces another part of the second other fixed electrode 22A in the third direction D3. For example, a length of the second opposing portion in the second direction D2 may be substantially the same as a length of the second other opposing portion in the second direction D2. At least a part of the second other movable electrode 32A is between a part of the second other fixed electrode 22A and another part of the second other fixed electrode 22A in the second direction D2. The vibration characteristics of the second beam 12 can be controlled more stably.

As shown in FIG. 1, the element section 10E may further include a second fixed structure 15b. The second fixed structure 15b is fixed to the base 50S. The second fixed structure 15b faces the second movable structure 12A. For example, the second fixed structure 15b faces the second other movable electrode 32A in the third direction D3. The potential of the second fixed structure 15b may be the same as the potential of the second movable structure 12A. The second fixed structure 15b may, for example, suppress excessive displacement of the second movable structure 12A. The second fixed structure 15b may, for example, be a stopper.

As shown in FIG. 1, the second movable electrode 32 and the second fixed electrode 22 may form a second comb-tooth electrode pair. The second movable electrode 32 and the second opposing fixed electrode 22C may form a second opposing comb-tooth electrode pair.

As shown in FIG. 1, for example, the second movable structure 12A may be symmetrical with respect to the first straight line Ln1. This allows for detection with higher accuracy. As shown in FIG. 2, a straight line passing through the center in the third direction D3 between the first beam 11 and the second beam 12 and extending along the second direction D2 is defined as a second straight line Ln2. The first member including the first beam 11 and the first movable structure 11A may be symmetrical with the second member including the second beam 12 and the second movable structure 12A, with the second straight line Ln2 as the axis. This enables detection with higher accuracy.

As shown in FIG. 1, in the example of the sensor 110, the element section 10E includes a second fixed portion 52F, a third fixed electrode 23, a third other fixed electrode 23A, a fourth fixed electrode 24, and a fourth other fixed electrode 24A. The second fixed portion 52F is fixed to the base 50S. For example, the second fixed portion 52F may be fixed to the base 50S via the first other fixed portion 50F. In this case, a gap may be provided between the base 50S and the second fixed portion 52F. The relative position of the second fixed portion 52F and the base 50S is substantially fixed. The third fixed electrode 23, the third other fixed electrode 23A, the fourth fixed electrode 24, and the fourth other fixed electrode 24A are fixed to the base 50S.

At least a part of the first other fixed portion 50F is between at least a part of the first fixed portion 51F and at least a part of the second fixed portion 52F in the second direction D2.

The first movable member 10M includes a third beam 13, a third movable structure 13A, a fourth beam 14, and a fourth movable structure 14A. The third beam 13 is between the fourth movable structure 14A and the third movable structure 13A in the third direction D3. The fourth beam 14 is between the fourth movable structure 14A and the third beam 13 in the third direction D3.

The third beam 13 includes a third beam portion 13a, a third other beam portion 13b, and a third intermediate beam portion 13c. The third beam 13 extends, for example, along the second direction D2. The third beam portion 13a is connected to the second fixed portion 52F. The third other beam portion 13b is connected to the first movable base 10A. A direction from the third other beam portion 13b to the third beam portion 13a is along the second direction D2. The third intermediate beam portion 13c is located between the third other beam portion 13b and the third beam portion 13a. The third intermediate beam portion 13c may be at the center of the third other beam portion 13b and the third beam portion 13a.

The third movable structure 13A includes a third movable electrode 33, a third other movable electrode 33A, and a third movable connecting portion 33C. A direction from the third movable electrode 33 to the third other movable electrode 33A is along the third direction D3. The third movable electrode 33 and the third other movable electrode 33A extend along the second direction D2. The third movable connecting portion 33C is connected to the third intermediate beam portion 13c. The third movable connecting portion 33C extends along the third direction D3. The third movable connecting portion 33C is connected to the third movable electrode 33 and the third other movable electrode 33A.

The fourth beam 14 includes a fourth beam portion 14a, a fourth other beam portion 14b, and a fourth intermediate beam portion 14c. The fourth beam 14 extends, for example, along the second direction D2. The fourth beam portion 14a is connected to the second fixed portion 52F. The fourth other beam portion 14b is connected to the first movable base 10A. A direction from the fourth other beam portion 14b to the fourth beam portion 14a is along the second direction D2. The fourth intermediate beam portion 14c is located between the fourth other beam portion 14b and the fourth beam portion 14a. The fourth intermediate beam portion 14c may be at the center of the fourth other beam portion 14b and the fourth beam portion 14a.

The fourth movable structure 14A includes a fourth movable electrode 34, a fourth other movable electrode 34A, and a fourth movable connecting portion 34C. A direction from the fourth other movable electrode 34A to the fourth movable electrode 34 is along the third direction D3. The fourth movable electrode 34 and the fourth other movable electrode 34A extend along the second direction D2. The fourth movable connecting portion 34C is connected to the fourth intermediate beam portion 14c. The fourth movable connecting portion 34C extends along the third direction D3. The fourth movable connecting portion 34C is connected to the fourth movable electrode 34 and the fourth other movable electrode 34A.

The controller 70 is configured to control a third potential E3 between the third other fixed electrode 23A and the third other movable electrode 33A in the first operation. The controller 70 is configured to control a fourth potential E4 between the fourth other fixed electrode 24A and the fourth other movable electrode 34A in the first operation.

The controller 70 may be configured to apply a second AC voltage V2 between the third fixed electrode 23 and the third movable electrode 33 in the second operation. The controller 70 may be configured to apply the second AC voltage V2 between the fourth fixed electrode 24 and the fourth movable electrode 34 in the second operation. The second AC voltage V2 may be different from the first AC voltage V1.

In the sensor 110, the controller 70 is configured to control the third potential E3 in the first operation to correct the third resonance characteristic of the third beam 13. The controller 70 is configured to control the fourth potential E4 in the first operation to correct the fourth resonance characteristic of the fourth beam 14.

For example, the controller 70 may be configured to make a third absolute value of the third potential E3 greater than a fourth absolute value of the fourth potential E4 in the first operation when the third resonant frequency of the third beam 13 is higher than the fourth resonant frequency of the fourth beam 14. The controller 70 may be configured to make the absolute value of the third potential E3 greater than 0 and the fourth absolute value of the fourth potential E4 substantially 0 in the first operation when the third resonant frequency is higher than the fourth resonant frequency.

For example, the controller 70 may be configured to make the fourth absolute value of the fourth potential E4 greater than the third absolute value of the third potential E3 in the first operation when the fourth resonant frequency of the fourth beam 14 is higher than the third resonant frequency of the third beam 13. The controller 70 may be configured to make the absolute value of the fourth potential E4 greater than 0 and the third absolute value of the third potential E3 substantially 0 in the first operation when the fourth resonant frequency is higher than the third resonant frequency.

The first potential E1, the second potential E2, the third potential E3 and the fourth potential E4 may be controlled, for example, by applying a DC voltage.

As described below, the third resonant frequency may be different from the first resonant frequency. The fourth resonant frequency may be different from the second resonant frequency. The characteristics (e.g., frequency) of the vibration based on the second AC voltage V2 may be different from the characteristics (e.g., frequency) of the vibration based on the first AC voltage V1.

The third movable structure 13A may be line-symmetrical with respect to a third straight line Ln3 that passes through the third intermediate beam portion 13c and is along the third direction D3. The fourth movable structure 14A may be line-symmetrical with respect to the third straight line Ln3.

As shown in FIGS. 1 and 3, the element section 10E may include an extending fixed portion 10B. The extending fixed portion 10B is connected to the first other fixed portion 50F. The extending fixed portion 10B is fixed to the base 50S. The extending fixed portion 10B may be fixed to the base 50S via the first other fixed portion 50F. In this case, a gap may be provided between the base 50S and the extending fixed portion 10B. The relative positions of the extending fixed portion 10B and the base 50S is substantially fixed. The first movable member 10M may further include a third movable base 10C and a fourth movable base 10D. The first movable base 10A is between the extending fixed portion 10B and the fourth movable base 10D in the third direction D3. The third movable base 10C is between the extending fixed portion 10B and the first movable base 10A in the third direction D3.

A third width (third length) of the third movable base 10C along the second direction D2 is shorter than a second width (second length) of the extending fixed portion 10B along the second direction D2. The third width (third length) is shorter than a first width (first length) of the first movable base 10A along the second direction D2. The third movable base 10C functions, for example, as a pivot portion. A fourth width (fourth length) of the fourth movable base 10D along the second direction D2 is longer than the second length and longer than the first length. The fourth movable base 10D functions, for example, as a proof mass. In response to the acceleration received by the element section 10E, the fourth movable base 10D is displaced, for example, along the second direction D2. The stress based on the displacement is effectively applied to the multiple beams. High sensitivity detection is implemented.

The third movable connecting portion 33C may be line-symmetrical to the first movable connecting portion 31C with respect to a fourth straight line Ln4 (see FIG. 2) that passes through the third movable base 10C and is along the third direction D3. The fourth movable connecting portion 34C may be line-symmetrical to the second movable connecting portion 32C with respect to the fourth straight line Ln4. The third movable connecting portion 33C may not be line-symmetrical to the first movable connecting portion 31C with respect to the fourth straight line Ln4. The fourth movable connecting portion 34C may not be line-symmetrical to the second movable connecting portion 32C with respect to the fourth straight line Ln4. The position of the third movable connecting portion 33C in the second direction D2 may be symmetrical to the position of the first movable connecting portion 31C in the second direction D2 with respect to the fourth straight line Ln4. The position of the fourth movable connecting portion 34C in the second direction D2 may be symmetrical to the position of the second movable connecting portion 32C in the second direction D2 with respect to the fourth straight line Ln4.

The first movable electrode 31 and the third movable electrode 33 may satisfy at least one of the first condition, the second condition, the third condition, the fourth condition, the fifth condition, the sixth condition, the seventh condition, the eighth condition, or the ninth condition.

In the first condition, a third mass of the third movable electrode 33 is different from a first mass of the first movable electrode 31. In the second condition, a third thickness of the third movable electrode 33 along the first direction is different from a first thickness of the first movable electrode 31 along the first direction. In the third condition, at least a part of a third material included in the third movable electrode 33 is different from at least a part of a first material included in the first movable electrode 31.

In the fourth condition, the third movable electrode 33 includes a third hole 33h, and the first movable electrode 31 does not include a hole (e.g., a first hole 31h). In the fifth condition, a third size of the third hole 33h included in the third movable electrode 33 is different from a first size of the first hole 31h included in the first movable electrode 31. In the sixth condition, a third density of the third holes 33h is different from a first density of the first holes 31h. In the seventh condition, a third number of the third holes 33h is different from a first number of the first holes 31h. In the eighth condition, a third shape of the third holes 33h is different from a first shape of the first holes 31h.

In the ninth condition, a third layer structure of the third movable electrode 33 is different from a first layer structure of the first movable electrode 31.

In these conditions, the vibration frequency of the structure including the third movable electrode 33 is different from the resonant frequency of the structure including the first movable electrode 31. For example, the third resonant frequency of the third beam 13 is different from the first resonant frequency of the first beam 11. For example, detection of a wide dynamic range is possible.

The second movable electrode 32 and the fourth movable electrode 34 may satisfy the same conditions as those described above.

The first condition may include that the third mass of the third movable electrode 33, the third other movable electrode 33A, and the third movable connecting portion 33C is different from the first mass of the first movable electrode 31, the first other movable electrode 31A, and the first movable connecting portion 31C. In the second condition, the third thickness along the first direction of the third movable electrode 33, the third other movable electrode 33A, and the third movable connecting portion 33C may be different from the first thickness along the first direction of the first movable electrode 31, the first other movable electrode 31A, and the first movable connecting portion 31C. The third condition may include that at least a part of the third material included in the third movable electrode 33, the third other movable electrode 33A, and the third movable connecting portion 33C is different from at least a part of the first material included in the first movable electrode 31, the first other movable electrode 31A, and the first movable connecting portion 31C.

The fourth condition may include that the third movable electrode 33, the third other movable electrode 33A, and the third movable connecting portion 33C include the third hole 33h, and the first movable electrode 31, the first other movable electrode 31A, and the first movable connecting portion 31C do not include a hole (e.g., the first hole 31h). In the fifth condition, the third size of the third hole 33h included in the third movable electrode 33, the third other movable electrode 33A, and the third movable connecting portion 33C may be different from the first size of the first hole 31h included in the first movable electrode 31, the first other movable electrode 31A, and the first movable connecting portion 31C. The ninth condition may include that the third layer structure of the third movable electrode 33, the third other movable electrode 33A, and the third movable connecting portion 33C may be different from the first layer structure of the first movable electrode 31, the first other movable electrode 31A, and the first movable connecting portion 31C.

In these conditions, the third resonant frequency of the third beam 13 is different from the first resonant frequency of the first beam 11. For example, detection of a wide dynamic range is possible.

The second movable electrode 32, the second other movable electrode 32A, the second movable connecting portion 32C, the fourth movable electrode 34, the fourth other movable electrode 34A, and the fourth movable connecting portion 34C may satisfy the same conditions as the above conditions. For example, the configuration of the third movable structure 13A may be different from the configuration of the first movable structure 11A. For example, the configuration of the fourth movable structure 14A may be different from the configuration of the fourth movable structure 14A.

As shown in FIG. 1, in the sensor 110, the element section 10E further includes a third opposing fixed electrode 23C and a fourth opposing fixed electrode 24C. The third opposing fixed electrode 23C and the fourth opposing fixed electrode 24C are fixed to the base 50S. The third opposing fixed electrode 23C faces the third movable electrode 33. The fourth opposing fixed electrode 24C faces the fourth movable electrode 34.

The controller 70 is configured to detect a third signal S3 between the third opposing fixed electrode 23C and the third movable electrode 33 in the second operation. The third signal S3 is configured to change in response to changes in the acceleration applied to the element section 10E. The controller 70 is configured to detect a fourth signal S4 between the fourth opposing fixed electrode 24C and the fourth movable electrode 34 in the second operation. The fourth signal S4 is configured to change in response to changes in the acceleration. The characteristics (e.g., frequency) of the vibration based on the second AC voltage V2 may be different from the characteristics (e.g., frequency) of the vibration based on the first AC voltage V1.

For example, the third signal S3 corresponds to a change in the third resonant frequency of the third beam 13, which changes in response to a change in the acceleration. For example, the fourth signal S4 corresponds to a change in the fourth resonant frequency of the fourth beam 14, which changes in response to a change in the acceleration. In the second operation, the controller 70 may be configured to output a third value being based on the first value and a second value corresponding to the difference between the fourth resonant frequency and the third resonant frequency.

As shown in FIG. 1, in the sensor 110, at least a part of the third movable electrode 33 is located between the third fixed electrode 23 and the third opposing fixed electrode 23C in the third direction D3.

In the third direction D3, the third movable electrode 33 is between the third beam 13 and the third other movable electrode 33A. A distance along the third direction D3 between the third beam 13 and the third movable electrode 33 is shorter than a distance along the third direction D3 between the third beam 13 and the third other movable electrode 33A. For example, stable detection operations and stable adjustment operations become easier.

For example, the distance along the third direction D3 between the third beam 13 and the third movable electrode 33 may be shorter than a distance along the third direction D3 between the third movable electrode 33 and the third other movable electrode 33A. The length along the second direction D2 of the third movable electrode 33 may be longer than the length along the second direction D2 of the third other movable electrode 33A.

In the example of FIG. 1, at least a part of the third other movable electrode 33A is between a part of the third other fixed electrode 23A and another part of the third other fixed electrode 23A in the third direction D3. The third other movable electrode 33A includes a portion (third opposing portion) that faces a part of the third other fixed electrode 23A in the third direction D3. The third other movable electrode 33A includes a portion (third other opposing portion) that faces another part of the third other fixed electrode 23A in the third direction D3. For example, a length of the third opposing portion in the second direction D2 may be substantially the same as a length of the third other opposing portion in the second direction D2. At least a part of the third other movable electrode 33A is between a part of the third other fixed electrode 23A and another part of the third other fixed electrode 23A in the second direction D2. The vibration characteristics of the first beam 11 can be controlled more stably.

As shown in FIG. 1, the element section 10E may further include a third fixed structure 15c. The third fixed structure 15c is fixed to the base 50S. The third fixed structure 15c faces the third movable structure 13A. For example, the third fixed structure 15c faces the third other movable electrode 33A in the third direction D3. The potential of the third fixed structure 15c may be the same as the potential of the third movable structure 13A. The third fixed structure 15c may, for example, suppress excessive displacement of the third movable structure 13A. The third fixed structure 15c may, for example, be a stopper.

As shown in FIG. 1, the third movable electrode 33 and the third fixed electrode 23 may form a third comb-tooth electrode pair. The third movable electrode 33 and the third opposing fixed electrode 23C may form a third opposing comb-tooth electrode pair.

As shown in FIG. 1, for example, the third movable structure 13A may be symmetrical with respect to a third straight line Ln3 that passes through the third intermediate beam portion 13c and is along the third direction D3. This allows for detection with higher accuracy.

As shown in FIG. 1, in the sensor 110, at least a part of the fourth movable electrode 34 is between the fourth fixed electrode 24 and the fourth opposing fixed electrode 24C in the third direction D3.

In the third direction D3, the fourth movable electrode 34 is between the fourth beam 14 and the fourth other movable electrode 34A. A distance along the third direction D3 between the fourth beam 14 and the fourth movable electrode 34 is shorter than a distance along the third direction D3 between the fourth beam 14 and the fourth other movable electrode 34A. For example, stable detection operations and stable adjustment operations become easier.

For example, the distance along the third direction D3 between the fourth beam 14 and the fourth movable electrode 34 may be shorter than a distance along the third direction D3 between the fourth movable electrode 34 and the fourth other movable electrode 34A. The length along the second direction D2 of the fourth movable electrode 34 may be longer than the length along the second direction D2 of the fourth other movable electrode 34A.

In the example of FIG. 1, at least a part of the fourth other movable electrode 34A is between a part of the fourth other fixed electrode 24A and another part of the fourth other fixed electrode 24A in the third direction D3. The fourth other movable electrode 34A includes a portion (fourth opposing portion) that faces a part of the fourth other fixed electrode 24A in the third direction D3. The fourth other movable electrode 34A includes a portion (fourth other opposing portion) that faces another part of the fourth other fixed electrode 24A in the third direction D3. For example, a length of the fourth opposing portion in the second direction D2 may be substantially the same as a length of the fourth other opposing portion in the second direction D2. At least a part of the fourth other movable electrode 34A is between a part of the fourth other fixed electrode 24A and another part of the fourth other fixed electrode 24A in the second direction D2. The vibration characteristics of the fourth beam 14 can be controlled more stably.

As shown in FIG. 1, the element section 10E may further include a fourth fixed structure 15d. The fourth fixed structure 15d is fixed to the base 50S. The fourth fixed structure 15d faces the fourth movable structure 14A. For example, the fourth fixed structure 15d faces the fourth other movable electrode 34A in the third direction D3. The potential of the fourth fixed structure 15d may be the same as the potential of the fourth movable structure 14A. The fourth fixed structure 15d may, for example, suppress excessive displacement of the fourth movable structure 14A. The fourth fixed structure 15d may, for example, be a stopper.

As shown in FIG. 1, the fourth movable electrode 34 and the fourth fixed electrode 24 may form a fourth comb-tooth electrode pair. The fourth movable electrode 34 and the fourth opposing fixed electrode 24C may form a fourth opposing comb-tooth electrode pair.

As shown in FIG. 1, for example, the fourth movable structure 14A may be symmetrical with respect to the third straight line Ln3. This allows for more accurate detection.

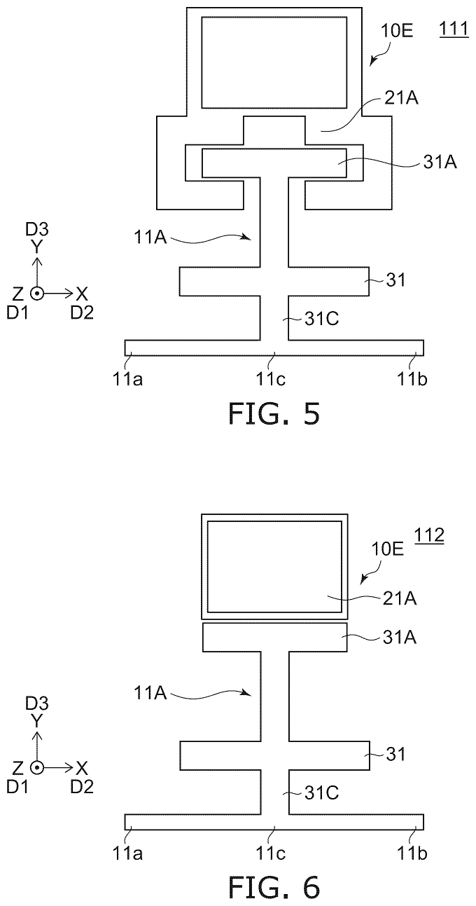

FIGS. 5 to 8 are schematic plan views illustrating a part of sensors according to the first embodiment.

These figures illustrate various configurations of the first beam 11 and the first movable structure 11A. In these figured, the first fixed electrode 21 and the first opposing fixed electrode 21C are omitted.

As shown in FIG. 5, in a sensor 111 according to the embodiment, the fixed structure (first fixed structure 15a) is omitted. In the sensor 111, the first other movable electrode 31A includes a portion (first opposing portion) that faces the first other fixed electrode 21A in the third direction D3. The first other movable electrode 31A includes a portion (first other opposing portion) that faces another part of the first other fixed electrode 21A in the third direction D3. For example, the length of the first opposing portion in the second direction D2 may be substantially the same as the length of the first other opposing portion in the second direction D2.

As shown in FIG. 6, in a sensor 112 according to the embodiment, the direction from the first other movable electrode 31A to the first other fixed electrode 21A is along the third direction D3. The first other movable electrode 31A is not sandwiched between multiple regions included in the first other fixed electrode 21A.

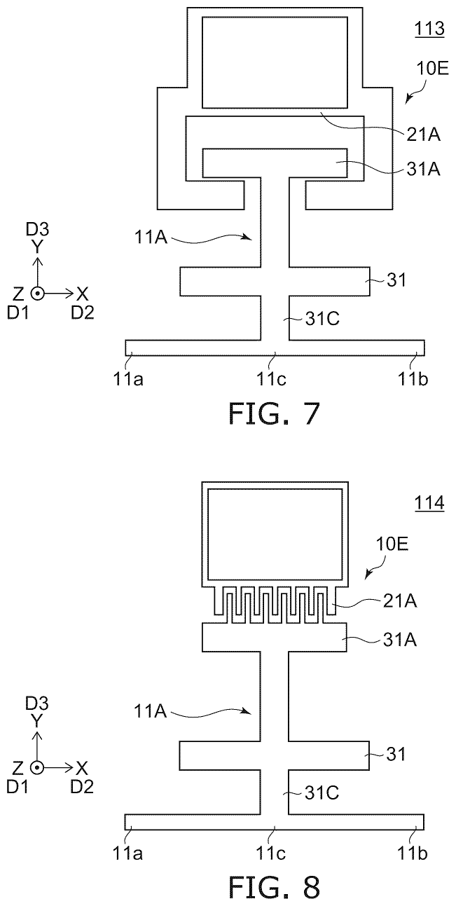

As shown in FIG. 7, in a sensor 113 according to the embodiment, a part of the first other movable electrode 31A is provided between one portion included in the first other fixed electrode 21A and another portion included in the first other fixed electrode 21A in the third direction D3. A distance along the third direction D3 between a part of the first other movable electrode 31A and a part included in the first other fixed electrode 21A is different from a distance along the third direction D3 between the part of the first other movable electrode 31A and another part included in the first other fixed electrode 21A.

As shown in FIG. 8, in a sensor 114 according to the embodiment, the first other movable electrode 31A and the first other fixed electrode 21A form comb-tooth electrodes.

In the sensors 111 to 114, the configuration of the portions except for those described above may be the same as the configuration of the sensor 110. In the sensors 111 to 114, the configuration described for the first other movable electrode 31A and the first other fixed electrode 21A may be applied to other movable electrodes and other fixed electrodes.

### Second Embodiment

The second embodiment relates to an electronic device.

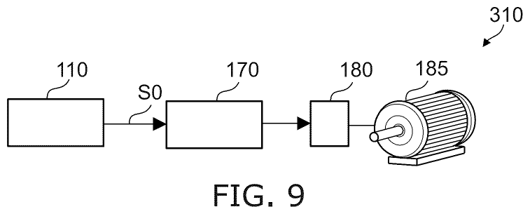

FIG. 9 is a schematic diagram illustrating an electronic device according to the second embodiment.

As shown in FIG. 9, an electronic device 310 according to the embodiment includes the sensor according to the first embodiment and a circuit controller 170. In the example of FIG. 9, the sensor 110 is illustrated as the sensor. The circuit controller 170 is configured to control a circuit 180 based on a detected signal S0 obtained from the sensor. The circuit 180 is, for example, a control circuit of a driving device 185 or the like. According to the embodiment, for example, the circuit 180 for controlling the driving device 185 can be controlled with high accuracy.

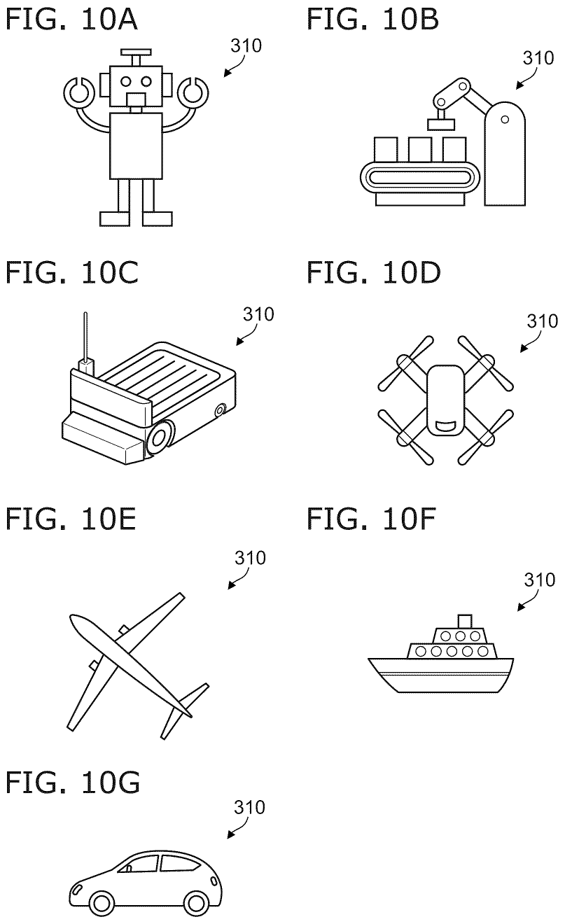

FIGS. 10A to 10G are schematic diagrams illustrating applications of the electronic device according to the embodiment.

As shown in FIG. 10A, the electronic device 310 may be at least a part of a robot. As shown in FIG. 10B, the electronic device 310 may be at least a part of a work robot provided in a manufacturing factory or the like. As shown in FIG. 10C, the electronic device 310 may be at least a part of an automated guided vehicle such as in a factory. As shown in FIG. 10D, the electronic device 310 may be at least a part of a drone (unmanned aerial vehicle). As shown in FIG. 10E, the electronic device 310 may be at least a part of an airplane. As shown in FIG. 10F, the electronic device 310 may be at least a part of a vessel. As shown in FIG. 10G, the electronic device 310 may be at least a part of an automobile. The electronic device 310 may include, for example, at least one of a robot or a mobile object.

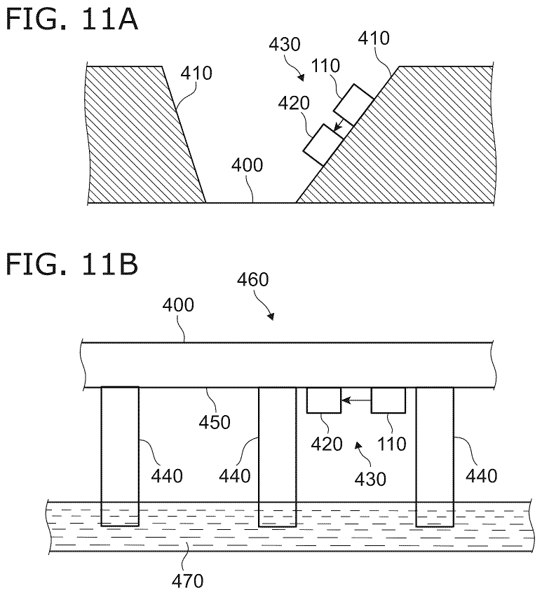

FIGS. 11A and 11B are schematic diagrams illustrating applications of the sensor according to the embodiment.

As shown in FIG. 11A, a sensor 430 according to the embodiment includes the sensor according to the first embodiment and a transmitter/receiver 420. In the example of FIG. 11A, the sensor 110 is drawn as the sensor. The transmitter/receiver 420 is configured to transmit the signal obtained from the sensor 110 by at least one of wireless or wired methods, for example. The sensor 430 is provided, for example, on a slope surface 410 such as a road 400. The sensor 430 may, for example, monitor conditions such as facilities (e.g., infrastructure). The sensor 430 may be, for example, a condition monitoring device.

For example, the sensor 430 detects changes in the state of the slope surface 410 of the road 400 with high accuracy. A change in the state of the slope surface 410 includes, for example, at least one of a change in tilt angle or a change in vibration state. The signal (test result) obtained from the sensor 110 is transmitted by the transmitter/receiver 420. The condition of facilities (e.g., infrastructure) can be monitored, e.g., continuously.

As shown in FIG. 11B, the sensor 430 is provided on a part of a bridge 460, for example. The bridge 460 is provided over a river 470. For example, the bridge 460 includes at least one of main girder 450 and a bridge pier 440. The sensor 430 is provided on at least one of the main girder 450 and the bridge pier 440. For example, the angle of at least one of the main girder 450 and the bridge pier 440 may change due to deterioration or the like. For example, in at least one of the main girder 450 and the bridge pier 440, the vibration state may change. The sensor 430 detects these changes with high accuracy. A detection result can be transmitted to an arbitrary place by the transmitter/receiver 420. Anomalies can be effectively detected.

The embodiments include the following Technical proposals:

### Technical Proposal 1

A sensor, comprising:
an element section; and
a controller,
the element section including:
   a base;
   a first fixed portion fixed to the base;
   a first other fixed portion fixed to the base;
   a first fixed electrode fixed to the base;
   a first other fixed electrode fixed to the base; and
   a first movable member,
a first gap being provided between the base and the first movable member,
the first movable member including:
   a first movable base supported by the first other fixed portion;
   a first beam; and
   a first movable structure,
the first beam including a first beam portion, a first other beam portion, and a first intermediate beam portion,
the first beam portion being connected to the first fixed portion,
the first other beam portion being connected to the first movable base,
a second direction from the first beam portion to the first other beam portion crossing a first direction from the base to the first other fixed portion,
the first intermediate beam portion being between the first beam portion and the first other beam portion,
the first movable structure including:
   a first movable electrode;
   a first other movable electrode; and
   a first movable connecting portion,
a direction from the first movable electrode to the first other movable electrode being along a third direction crossing a plane including the first direction and the second direction,
the first movable electrode and the first other movable electrode extending along the second direction,
the first movable connecting portion being connected to the first intermediate beam portion,
the first movable connecting portion extending along the third direction,
the first movable connecting portion being connected to the first movable electrode and the first other movable electrode,
the controller being configured to perform a first operation and a second operation,
the controller being configured to control a first potential between the first other fixed electrode and the first other movable electrode in the first operation, and
the controller being configured to apply a first AC voltage between the first fixed electrode and the first movable electrode in the second operation.

### Technical Proposal 2

The sensor according to Technical proposal 1, further comprising:
the element section including a first opposing fixed electrode fixed to the base,
the first opposing fixed electrode facing the first movable electrode,
the controller being configured to detect a first signal between the first opposing fixed electrode and the first movable electrode in the second operation,
the first signal being configured to change in response to a change in an acceleration applied to the element section.

### Technical Proposal 3

The sensor according to Technical proposal 2, wherein
the first signal is responsive to a change in a first resonant frequency of the first beam being responsive to the change in the acceleration.

### Technical Proposal 4

The sensor according to Technical proposal 2, wherein
the controller is configured to control the first potential in the first operation to correct a first resonance characteristic of the first beam.

### Technical Proposal 5

The sensor according to any one of Technical proposals 2-4, wherein
at least a part of the first movable electrode is between the first fixed electrode and the first opposing fixed electrode in the third direction.

### Technical Proposal 6

The sensor according to any one of Technical proposals 1-5, wherein
in the third direction, the first movable electrode is between the first beam and the first other movable electrode.

### Technical Proposal 7

The sensor according to any one of Technical proposals 1-6, wherein
at least a part of the first other movable electrode is between a part of the first other fixed electrode and another part of the first other fixed electrode in the third direction.

### Technical Proposal 8

The sensor according to any one of Technical proposals 1-7, wherein
the element section further includes a first fixed structure fixed to the base, and
the first fixed structure faces the first movable structure.

### Technical Proposal 9

The sensor according to Technical proposal 2, wherein
the first movable electrode and the first fixed electrode form a first comb-tooth electrode pair, and
the first movable electrode and the first opposing fixed electrode constitute a first opposing comb-tooth electrode pair.

### Technical Proposal 10

The sensor according to any one of Technical proposals 1-9, wherein
the first movable structure is symmetrical with respect to a first line passing through the first intermediate beam portion and being along the third direction.

### Technical Proposal 11

The sensor according to Technical proposal 3, wherein
the element section includes:
   a second fixed electrode fixed to the base, and
   a second other fixed electrode fixed to the base,
the first movable member further includes a second beam and a second movable structure,
the first beam is between the second movable structure and the first movable structure in the third direction,
the second beam is between the second movable structure and the first beam in the third direction,
the second beam includes a second beam portion, a second other beam portion, and a second intermediate beam portion,
the second beam portion is connected to the first fixed portion,
the second other beam portion is connected to the first movable base,
a direction from the second beam portion to the second other beam portion is along the second direction,
the second intermediate beam portion is between the second beam portion and the second other beam portion,
the second movable structure includes:
   a second movable electrode;
   a second other movable electrode, and
   a second movable connecting portion,
a direction from the second other movable electrode to the second movable electrode is along the third direction,
the second movable electrode and the second other movable electrode extend along the second direction,
the second movable connecting portion is connected to the second intermediate beam portion,
the second movable connecting portion extends along the third direction,
the second movable connecting portion is connected to the second movable electrode and the second other movable electrode,
the controller is configured to control a second potential between the second other fixed electrode and the second other movable electrode in the first operation, and
the controller is configured to apply a second AC voltage between the second fixed electrode and the second movable electrode in the second operation.

### Technical Proposal 12

The sensor according to Technical proposal 11, wherein
the element section further includes a second opposing fixed electrode fixed to the base,
the second opposing fixed electrode faces the second movable electrode,
the controller is configured to detect a second signal between the second opposing fixed electrode and the second movable electrode in the second operation, and
the second signal is configured to change in response to the change in the acceleration.

### Technical Proposal 13

The sensor according to Technical proposal 12, wherein
the second signal corresponds to a change in a second resonant frequency of the second beam, the change in the second resonant frequency changing in response to the change in the acceleration, and
the controller is configured to output a first value based on the first signal and the second signal in the second operation.

### Technical Proposal 14

The sensor according to Technical proposal 13, wherein
the controller is configured to control the second potential in the first operation to correct a second resonance characteristic of the second beam.

### Technical Proposal 15

The sensor according to Technical proposal 13, wherein
in the first operation, the controller is configured to make a first absolute value of the first potential larger than a second absolute value of the second potential when the first resonant frequency is higher than the second resonant frequency.

### Technical Proposal 16

The sensor according to Technical proposal 13, wherein
the element section includes:
   a second fixed portion fixed to the base;
   a third fixed electrode fixed to the base;
   a third other fixed electrode fixed to the base;
   a fourth fixed electrode fixed to the base; and
   a fourth other fixed electrode fixed to the base,
at least a part of the first other fixed portion is located between at least a part of the first fixed portion and at least a part of the second fixed portion in the second direction,
the first movable member includes:
   a third beam;
   a third movable structure;
   a fourth beam; and
   a fourth movable structure,
the third beam is between the fourth movable structure and the third movable structure in the third direction,
the fourth beam is between the fourth movable structure and the third beam in the third direction,
the third beam includes a third beam portion, a third other beam portion, and a third intermediate beam portion,
the third beam portion is connected to the second fixed portion,
the third other beam portion is connected to the first movable base,
a direction from the third other beam portion to the third beam portion is along the second direction,
the third intermediate beam portion is between the third other beam portion and the third beam portion,
the third movable structure includes:
   a third movable electrode;
   a third other movable electrode; and
   a third movable connecting portion,
a direction from the third movable electrode to the third other movable electrode is along the third direction,
the third movable electrode and the third other movable electrode extend along the second direction,
the third movable connecting portion is connected to the third intermediate beam part,
the third movable connecting portion extends along the third direction,
the third movable connecting portion is connected to the third movable electrode and the third other movable electrode,
the fourth beam includes a fourth beam portion, a fourth other beam portion, and a fourth intermediate beam portion,
the fourth beam portion is connected to the second fixed portion,
the fourth beam portion is connected to the first movable base,
a direction from the fourth beam portion to the fourth beam portion is along the second direction,
the fourth intermediate beam portion is between the fourth beam portion and the fourth beam portion,
the fourth movable structure includes:
   a fourth movable electrode;
   a fourth other movable electrode; and
   a fourth movable connection portion,
a direction from the fourth other movable electrode to the fourth movable electrode is along the third direction,
the fourth movable electrode and the fourth other movable electrode extend along the second direction,
the fourth movable connection portion is connected to the fourth intermediate beam portion,
the fourth movable connecting portion extends along the third direction,
the fourth movable connecting portion is connected to the fourth movable electrode and the fourth other movable electrode,
the controller is configured to control a third potential between the third other fixed electrode and the third other movable electrode in the first operation,
the controller is configured to control a fourth potential between the fourth other fixed electrode and the fourth other movable electrode in the first operation,
the controller is configured to apply the first AC voltage between the third fixed electrode and the third movable electrode in the second operation,
the controller is configured to apply the first AC voltage between the fourth fixed electrode and the fourth movable electrode in the second operation.

### Technical Proposal 17

The sensor according to Technical proposal 16, wherein
the first movable member further includes a second movable base, a third movable base, and a fourth movable base,
the second movable base is supported by the first other fixed portion,
the first movable base is between the second movable base and the fourth movable base in the third direction,
the third movable base is between the second movable base and the first movable base in the third direction,
a third length of the third movable base along the second direction is shorter than a second length of the second movable base along the second direction and shorter than a first length of the first movable base along the second direction,
a fourth length of the fourth movable base along the second direction is longer than the second length and longer than the first length,
the third movable connecting portion is symmetrical to the first movable connecting portion with respect to a fourth straight line passing through the third movable base along the third direction,
the fourth movable connecting portion is symmetrical to the second movable connecting portion with respect to the fourth straight line,
the first movable electrode and the third movable electrode satisfy at least one of a first condition, a second condition, a third condition, a fourth condition, a fifth condition, a sixth condition, a seventh condition, an eighth condition, or a ninth condition,
in the first condition, a third mass of the third movable electrode is different from a first mass of the first movable electrode,
in the second condition, a third thickness of the third movable electrode along the first direction is different from a first thickness of the first movable electrode along the first direction,
in the third condition, at least a part of a third material included in the third movable electrode is different from at least a part of a first material included in the first movable electrode,
in the fourth condition, the third movable electrode includes a third hole and the first movable electrode does not include a first hole,
in the fifth condition, a third size of the third hole included in the third movable electrode is different from a first size of the first hole included in the first movable electrode,
in the sixth condition, a third density of the third holes is different from a first density of the first holes,
in the seventh condition, a third number of the third holes is different from a first number of the first holes,
in the eighth condition, a third shape of the third holes is different from a first shape of the first holes,
in the ninth condition, a third layer structure of the third movable electrode is different from a first layer structure of the first movable electrode.

### Technical Proposal 18

The sensor according to Technical proposal 16 or 17, wherein
the element section further includes:
   a third opposing fixed electrode fixed to the base, and
   a fourth opposing fixed electrode fixed to the base,
the third opposing fixed electrode faces the third movable electrode,
the fourth opposing fixed electrode faces the fourth movable electrode,
the controller is configured to detect a third signal between the third opposing fixed electrode and the third movable electrode in the second operation, and
the third signal is configured to change in response to the change in the acceleration,
the controller is configured to detect a fourth signal between the fourth opposing fixed electrode and the fourth movable electrode in the second operation;
the fourth signal is configured to change in response to the change in the acceleration,
the third signal changes in response to a change in a third resonant frequency of the third beam, the change in the third resonant frequency changing in response to the change in the acceleration,
the fourth signal changes in response to a change in a fourth resonant frequency of the fourth beam, the change in the fourth resonant frequency changing in response to the change in the acceleration,
in the second operation, the controller is configured to output a third value being based on a first value and a second value, the second value corresponding to a difference between the third resonance frequency and the third resonance frequency.

### Technical Proposal 19

The sensor according to Technical proposal 18, wherein
the controller is configured to control the third potential in the first operation to correct a third resonance characteristic of the third beam,
the controller is configured to control the fourth potential in the first operation to correct a fourth resonance characteristic of the fourth beam,
in the first operation, the controller is configured to make a third absolute value of the third potential larger than a fourth absolute value of the fourth potential when the third resonant frequency is higher than the fourth resonant frequency.

### Technical Proposal 20

An electronic device comprising:
the sensor according to any one of Technical proposals 1-19; and
a circuit controller configured to control a circuit based on a signal obtained from the sensor.

According to the embodiments, a sensor and an electronic device that can improve performance.

Hereinabove, exemplary embodiments of the invention are described with reference to specific examples. However, the embodiments of the invention are not limited to these specific examples. For example, one skilled in the art may similarly practice the invention by appropriately selecting specific configurations of components included in sensors such as bases, element sections, fixed portions, controllers, etc., from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all sensors and all electronic devices practicable by an appropriate design modification by one skilled in the art based on the sensors and the electronic devices described above as embodiments of the invention also are within the scope of the invention to the extent that the purport of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A sensor, comprising:
an element section; and
a controller,
the element section including:
a base;
a first fixed portion fixed to the base;
a first other fixed portion fixed to the base;
a first fixed electrode fixed to the base;
a first other fixed electrode fixed to the base; and
a first movable member,
a first gap being provided between the base and the first movable member,
the first movable member including:
a first movable base supported by the first other fixed portion;
a first beam; and
a first movable structure,
the first beam including a first beam portion, a first other beam portion, and a first intermediate beam portion,
the first beam portion being connected to the first fixed portion,
the first other beam portion being connected to the first movable base,
a second direction from the first beam portion to the first other beam portion crossing a first direction from the base to the first other fixed portion,
the first intermediate beam portion being between the first beam portion and the first other beam portion,
the first movable structure including:
a first movable electrode;
a first other movable electrode; and
a first movable connecting portion,
a direction from the first movable electrode to the first other movable electrode being along a third direction crossing a plane including the first direction and the second direction,
the first movable electrode and the first other movable electrode extending along the second direction,
the first movable connecting portion being connected to the first intermediate beam portion,
the first movable connecting portion extending along the third direction,
the first movable connecting portion being connected to the first movable electrode and the first other movable electrode,
the controller being configured to perform a first operation and a second operation,
the controller being configured to control a first potential between the first other fixed electrode and the first other movable electrode in the first operation, and
the controller being configured to apply a first AC voltage between the first fixed electrode and the first movable electrode in the second operation.

2. The sensor according to claim 1, further comprising:
the element section including a first opposing fixed electrode fixed to the base,
the first opposing fixed electrode facing the first movable electrode,
the controller being configured to detect a first signal between the first opposing fixed electrode and the first movable electrode in the second operation,
the first signal being configured to change in response to a change in an acceleration applied to the element section.

3. The sensor according to claim 2, wherein
the first signal is responsive to a change in a first resonant frequency of the first beam being responsive to the change in the acceleration.

4. The sensor according to claim 2, wherein
the controller is configured to control the first potential in the first operation to correct a first resonance characteristic of the first beam.

5. The sensor according to claim 2, wherein
at least a part of the first movable electrode is between the first fixed electrode and the first opposing fixed electrode in the third direction.

6. The sensor according to claim 1, wherein
in the third direction, the first movable electrode is between the first beam and the first other movable electrode.

7. The sensor according to claim 1, wherein
at least a part of the first other movable electrode is between a part of the first other fixed electrode and another part of the first other fixed electrode in the third direction.

8. The sensor according to claim 1, wherein
the element section further includes a first fixed structure fixed to the base, and
the first fixed structure faces the first movable structure.

9. The sensor according to claim 2, wherein
the first movable electrode and the first fixed electrode form a first comb-tooth electrode pair, and
the first movable electrode and the first opposing fixed electrode constitute a first opposing comb-tooth electrode pair.

10. The sensor according to claim 1, wherein
the first movable structure is symmetrical with respect to a first line passing through the first intermediate beam portion and being along the third direction.

11. The sensor according to claim 3, wherein
the element section includes:
a second fixed electrode fixed to the base, and
a second other fixed electrode fixed to the base,
the first movable member further includes a second beam and a second movable structure,
the first beam is between the second movable structure and the first movable structure in the third direction,
the second beam is between the second movable structure and the first beam in the third direction,
the second beam includes a second beam portion, a second other beam portion, and a second intermediate beam portion,
the second beam portion is connected to the first fixed portion,
the second other beam portion is connected to the first movable base,
a direction from the second beam portion to the second other beam portion is along the second direction,
the second intermediate beam portion is between the second beam portion and the second other beam portion,
the second movable structure includes:
a second movable electrode;
a second other movable electrode, and
a second movable connecting portion,
a direction from the second other movable electrode to the second movable electrode is along the third direction,
the second movable electrode and the second other movable electrode extend along the second direction,
the second movable connecting portion is connected to the second intermediate beam portion,
the second movable connecting portion extends along the third direction,
the second movable connecting portion is connected to the second movable electrode and the second other movable electrode,
the controller is configured to control a second potential between the second other fixed electrode and the second other movable electrode in the first operation, and
the controller is configured to apply a second AC voltage between the second fixed electrode and the second movable electrode in the second operation.

12. The sensor according to claim 11, wherein
the element section further includes a second opposing fixed electrode fixed to the base,
the second opposing fixed electrode faces the second movable electrode,
the controller is configured to detect a second signal between the second opposing fixed electrode and the second movable electrode in the second operation, and
the second signal is configured to change in response to the change in the acceleration.

13. The sensor according to claim 12, wherein
the second signal corresponds to a change in a second resonant frequency of the second beam, the change in the second resonant frequency changing in response to the change in the acceleration, and
the controller is configured to output a first value based on the first signal and the second signal in the second operation.

14. The sensor according to claim 13, wherein
the controller is configured to control the second potential in the first operation to correct a second resonance characteristic of the second beam.

15. The sensor according to claim 13, wherein
in the first operation, the controller is configured to make a first absolute value of the first potential larger than a second absolute value of the second potential when the first resonant frequency is higher than the second resonant frequency.

16. The sensor according to claim 13, wherein
the element section includes:
a second fixed portion fixed to the base;
a third fixed electrode fixed to the base;
a third other fixed electrode fixed to the base;
a fourth fixed electrode fixed to the base; and
a fourth other fixed electrode fixed to the base,
at least a part of the first other fixed portion is located between at least a part of the first fixed portion and at least a part of the second fixed portion in the second direction,
the first movable member includes:
a third beam;
a third movable structure;
a fourth beam; and
a fourth movable structure,
the third beam is between the fourth movable structure and the third movable structure in the third direction,
the fourth beam is between the fourth movable structure and the third beam in the third direction,
the third beam includes a third beam portion, a third other beam portion, and a third intermediate beam portion,
the third beam portion is connected to the second fixed portion,
the third other beam portion is connected to the first movable base,
a direction from the third other beam portion to the third beam portion is along the second direction,
the third intermediate beam portion is between the third other beam portion and the third beam portion,
the third movable structure includes:
a third movable electrode;
a third other movable electrode; and
a third movable connecting portion,
a direction from the third movable electrode to the third other movable electrode is along the third direction,
the third movable electrode and the third other movable electrode extend along the second direction,
the third movable connecting portion is connected to the third intermediate beam part,
the third movable connecting portion extends along the third direction,
the third movable connecting portion is connected to the third movable electrode and the third other movable electrode,
the fourth beam includes a fourth beam portion, a fourth other beam portion, and a fourth intermediate beam portion,
the fourth beam portion is connected to the second fixed portion,
the fourth beam portion is connected to the first movable base,
a direction from the fourth beam portion to the fourth beam portion is along the second direction,
the fourth intermediate beam portion is between the fourth beam portion and the fourth beam portion,
the fourth movable structure includes:
a fourth movable electrode;
a fourth other movable electrode; and
a fourth movable connection portion,
a direction from the fourth other movable electrode to the fourth movable electrode is along the third direction,
the fourth movable electrode and the fourth other movable electrode extend along the second direction,
the fourth movable connection portion is connected to the fourth intermediate beam portion,
the fourth movable connecting portion extends along the third direction,
the fourth movable connecting portion is connected to the fourth movable electrode and the fourth other movable electrode,
the controller is configured to control a third potential between the third other fixed electrode and the third other movable electrode in the first operation,
the controller is configured to control a fourth potential between the fourth other fixed electrode and the fourth other movable electrode in the first operation,
the controller is configured to apply the first AC voltage between the third fixed electrode and the third movable electrode in the second operation,
the controller is configured to apply the first AC voltage between the fourth fixed electrode and the fourth movable electrode in the second operation.

17. The sensor according to claim 16, wherein
the first movable member further includes a second movable base, a third movable base, and a fourth movable base,
the second movable base is supported by the first other fixed portion,
the first movable base is between the second movable base and the fourth movable base in the third direction,
the third movable base is between the second movable base and the first movable base in the third direction,
a third length of the third movable base along the second direction is shorter than a second length of the second movable base along the second direction and shorter than a first length of the first movable base along the second direction,
a fourth length of the fourth movable base along the second direction is longer than the second length and longer than the first length,
the third movable connecting portion is symmetrical to the first movable connecting portion with respect to a fourth straight line passing through the third movable base along the third direction,
the fourth movable connecting portion is symmetrical to the second movable connecting portion with respect to the fourth straight line,
the first movable electrode and the third movable electrode satisfy at least one of a first condition, a second condition, a third condition, a fourth condition, a fifth condition, a sixth condition, a seventh condition, an eighth condition, or a ninth condition,
in the first condition, a third mass of the third movable electrode is different from a first mass of the first movable electrode,
in the second condition, a third thickness of the third movable electrode along the first direction is different from a first thickness of the first movable electrode along the first direction,
in the third condition, at least a part of a third material included in the third movable electrode is different from at least a part of a first material included in the first movable electrode,
in the fourth condition, the third movable electrode includes a third hole and the first movable electrode does not include a first hole,
in the fifth condition, a third size of the third hole included in the third movable electrode is different from a first size of the first hole included in the first movable electrode,
in the sixth condition, a third density of the third holes is different from a first density of the first holes,
in the seventh condition, a third number of the third holes is different from a first number of the first holes,
in the eighth condition, a third shape of the third holes is different from a first shape of the first holes,
in the ninth condition, a third layer structure of the third movable electrode is different from a first layer structure of the first movable electrode.

18. The sensor according to claim 16, wherein
the element section further includes:
a third opposing fixed electrode fixed to the base, and
a fourth opposing fixed electrode fixed to the base,
the third opposing fixed electrode faces the third movable electrode,
the fourth opposing fixed electrode faces the fourth movable electrode,
the controller is configured to detect a third signal between the third opposing fixed electrode and the third movable electrode in the second operation, and
the third signal is configured to change in response to the change in the acceleration,
the controller is configured to detect a fourth signal between the fourth opposing fixed electrode and the fourth movable electrode in the second operation;
the fourth signal is configured to change in response to the change in the acceleration,
the third signal changes in response to a change in a third resonant frequency of the third beam, the change in the third resonant frequency changing in response to the change in the acceleration,
the fourth signal changes in response to a change in a fourth resonant frequency of the fourth beam, the change in the fourth resonant frequency changing in response to the change in the acceleration,
in the second operation, the controller is configured to output a third value being based on a first value and a second value, the second value corresponding to a difference between the third resonance frequency and the third resonance frequency.

19. The sensor according to claim 18, wherein
the controller is configured to control the third potential in the first operation to correct a third resonance characteristic of the third beam,
the controller is configured to control the fourth potential in the first operation to correct a fourth resonance characteristic of the fourth beam,
in the first operation, the controller is configured to make a third absolute value of the third potential larger than a fourth absolute value of the fourth potential when the third resonant frequency is higher than the fourth resonant frequency.

20. An electronic device comprising:
the sensor according to claim 1; and
a circuit controller configured to control a circuit based on a signal obtained from the sensor.
